(19) United States
(12) Patent Application Publication
(10) Pub. No.: US 2017/0324285 A1
(43) Pub. Date: Nov. 9, 2017

(54) STATOR FOR AN ELECTRIC MOTOR AND METHOD FOR THE PRODUCTION THEREOF

(71) Applicant: Brose Fahrzeugteile GmbH & Co. Kommanditgesellschaft, Wuerzburg (DE)

(72) Inventors: Gerhard BROHM, Veitshoechheim (DE); Matthias KOCH, Waldbuettelbrunn (DE); Peter PSZOLA, Bonn (DE); Jásmin KURBEGOVIC-ZRNIC, Wuerzburg (DE)

(73) Assignee: Brose Fahrzeugteile GmbH & Co. Kommanditgesellschaft, Wuerzburg (DE)

(21) Appl. No.: 15/660,120

(22) Filed: Jul. 26, 2017

Related U.S. Application Data
(63) Continuation of application No. PCT/EP2016/051280, filed on Jan. 22, 2016.

(30) Foreign Application Priority Data
Jan. 26, 2015 (DE) 10 2015 000 769.6

(51) Int. Cl. H02K 1/14; H02K 1/18; H02K 3/52; H02K 3/32; H02K 5/22

(52) U.S. Cl. CPC H02K 1/148; H02K 3/522; H02K 3/325; H02K 1/187; H02K 5/225; H02K 2213/03

(57) ABSTRACT

A stator for an electric motor, in particular the steering motor of a motor vehicle, comprising a cylindrical stator yoke and a stator star joined therewith and having a number of radially outwardly directed stator teeth, the tooth tips thereof, in the assembly state, resting on the inner circumference of the stator yoke in corresponding connection points. The tooth tips on the stator star side, in the assembly state, in addition to being force-locked or frictionally locked with the connecting points on the stator yoke side in a press-fit, are also integrally bonded thereto.

This nonprovisional application is a continuation of International Application No. PCT/EP2016/051280, which was filed on Jan. 22, 2016, and which claims priority to German Patent Application No. 10 2015 000 769.6, which was filed in Germany on Jan. 26, 2015, and which are both herein incorporated by reference.

### BACKGROUND OF THE INVENTION

### Field of the Invention

The invention relates to a stator for an electric motor, in particular for a steering motor of a motor vehicle, comprising a cylindrical stator yoke and a stator star joined therewith and having a number of radially outwardly directed stator teeth, the tooth tips of which rest on corresponding connection points on the inner circumference of the stator yoke when in the joined state. It also relates to a method for producing such a stator, in particular of a steering motor of a motor vehicle.

### Description of the Background Art

An electric motor comprises a stator forming the fixed motor part and a rotor forming the moving motor part. In an internal rotor motor, the stator is usually provided with a stator yoke, on which stator teeth are arranged, which project inwards and radially towards the center, and whose free ends facing the rotor form the so-called pole shoe. Coils are mounted on the stator teeth which generate a magnetic field during electromotive operation.

In order to provide access to the stator teeth from the outside in the production of the stator for the winding of the stator teeth with the coils assigned to them, standard practice is to use a multi-part structure of the stator with stator teeth directed radially outwards from the pole shoe, as is known, for example, from DE 10 2013 003 024 A1 (which corresponds to US 2016/0111929), from DE 10 2013 007 730 A1 or from DE 10 2012 021 132 A1. For this purpose, in the case of the known stator, a laminated core with star-shaped stator teeth (star laminated core) is produced, which teeth are connected to one another by way of pole shoe webs in order to achieve a mechanically stable composite. In this case, the stator is produced from individual, punched stator laminated sheets, in that they are stacked into the star-shaped laminated core in a mechanically stable composite.

Following the fitting of the stator teeth, which are accessible from the outside, with the windings (coil windings), preferably by means of so-called coil carriers, the star laminated core provided with coils or coil carriers, pushed radially from the outside onto the stator teeth, is inserted into the stator yoke forming a magnetic return ring and is fitted by means of pressing or shrinkage. The stator yoke can also be designed as a laminated core of annular stator laminations (annular laminated core).

However, the technically advantageous separation between the star-shaped stator component, which is hereinafter referred to as stator star, and the (cylindrical) stator yoke as a further stator component has the acoustic disadvantage that in the case of an electric motor equipped with such a stator, the operating-induced electromagnetic forces excite vibrations throughout the stator. Due to the separation between the stator star and the stator yoke, a resonance frequency occurs in a range, in particular at approx. 1350 Hz, which, when using such an electric motor, in particular in the case of a steering motor, is transmitted as a body sound from engine compartment structures, for example, from the steering system over corresponding structures in the engine compartment into the interior of a motor vehicle where it is perceived as a disturbing air-borne noise.

### SUMMARY OF THE INVENTION

It is therefore an object of the invention to provide a stator of the above-mentioned type which is improved in terms of its acoustic behavior, in particular during its use and intended operation in an electric motor, preferably a steering motor of a motor vehicle. Furthermore, a suitable method for producing such a stator is to be provided. Furthermore, an electric motor, in particular a steering motor for a motor vehicle, is to be specified with such a stator. With regard to the stator, this object is achieved according to the invention with the features of claim 1. With regard to the method, the stated object is achieved according to the invention according to a first variant with the features of claim 6 and according to a second variant with the features of claim 8. Advantageous embodiments and further developments are the subject matter of the dependent claims.

With regard to the stator, this stator can have a stator yoke as a cylindrical outer stator component and a stator star as a star-shaped inner stator component having a number of radially outwardly directed stator teeth, which are used to receive coils, in particular also in connection with coil elements of a stator winding. In the joined state of the stator star and the stator yoke, the free end side tooth tips of the stator teeth adjoin corresponding connection points on the inner circumference of the stator yoke. Between at least some of the tooth tips, preferably between all tooth tips, and the respectively corresponding connection point on the inner circumference of the stator yoke, an integral bond is produced in the joined state in addition to the force-locked or frictionally locked connection. The integral bond is preferably realized by means of an adhesive. Alternatively, this can also be produced as a welded connection.

The invention is based on the consideration that, on the one hand, the acoustic behavior of such a stator with separation between the stator star and the stator yoke is attributable to a resonance frequency of typically less than 1500 Hz perceived within a vehicle as a body sound, and that on the other hand, an increase of this resonance frequency due to the frequency-dependent damping in a vehicle, the sound levels in the vehicle interior can be reduced. In fact this damping is known to occur from a frequency range of approximately 1500 Hz to 2000 Hz, so that an increase in the resonance frequency by a corresponding amount of typically only a few 100 Hz would already lead to a significant improvement in the acoustic behavior in the vehicle.

A comparatively stiff assembly should be produced as a suitable measure for shifting the resonance frequency of the from the stator star and the stator yoke into the range of 1500 Hz to 2000 Hz. This can in turn be carried out in a reliable and simple manner by an additional connection technique, namely by gluing or welding, for pressing the stator star and the stator yoke.

In addition to the force-locked or frictionally locked connection between the stator star and the stator yoke, both variants, namely gluing and welding, establish an integral bond between the stator teeth or their tooth tips and the connection points corresponding to the yoke side, so that, as compared to a bond comprising the stator star and the stator yoke, a substantially more rigid bond is formed with only one force-locked or frictionally locked connection.

In an embodiment, the tooth tips of the stator teeth are formed with suitably wedge-shaped joining contours and the corresponding connection points on the inner circumference of the stator yoke are formed with diametrically opposed joining contours. In this way, on the one hand a position-accurate interfit of stator star and stator yoke is achieved. On the other hand, these joining contours offer comparatively large and in particular full-surface contact of the tooth tips on the corresponding connection points of the stator yoke. The term “abutment” of the star-side tooth tips on the connection points on the yoke side is therefore also understood to include the insertion of the tooth tips in the corresponding connection points, in particular when the corresponding joining locations are formed as a wedge or the like according to the advantageous embodiment.

The stator yoke can be designed as a cylindrical solid body, while the star-shaped stator component, that is to say the stator star, which is disposed in the stator yoke in the stator mounting state, is formed as a laminated core, for example with alternately closed and at least partially open stator laminations. However, the stator yoke may also be formed as a laminated core of annular stator laminations stacked in the axial direction.

An especially microencapsulated two-component hard adhesive is particularly preferred as an adhesive for the additional integral bond of the two components of the stator bond made up of stator star and stator yoke, in the region between the stator teeth or their tooth tips and the corresponding connection points on the inner circumference of the stator yoke. Also conceivable is a one-component silicone adhesive. However, this possibly increases the required pressing force when joining the stator star and the stator yoke as compared to the two-component hard adhesive (2-component adhesive, for example GP14).

The use of such a microencapsulated two-component hard adhesive also offers the advantage that the corresponding adhesive can be applied to the tooth tips of the stator star, and the property is exploited that the adhesive is activated only by pressing the stator yoke on the stator star itself and that it cures at room temperature. Thus, the microencapsulated adhesive can already be applied to the stator teeth thereof, preferably over the entire area, during production of the stator star.

In order to produce such a stator, the or at least some of the connection points between the cylindrical stator yoke and the star-shaped stator component (stator star) are provided with an adhesive before the joining process, and the stator yoke and the star-shaped stator component are then bonded together and pressed, the stator yoke being applied to the star-shaped stator component or pressed into the stator yoke.

For example, in the case of a manufactured stator star, the microencapsulated hard adhesive is applied as an adhesive to the free end tooth tips of the radially outwardly directed stator teeth, for example over the entire surface. In this case, the property of such an adhesive is utilized such that it becomes active with regard to its adhesive property only during the pressing of the stator star and of the stator yoke and also cures at room temperature following the bonding and pressing process.

The advantages achieved with the invention include, for example, the fact that an additional adhesion of a stator star with radially outwardly directed stator teeth and a cylindrical stator yoke results in increased stiffness of a stator joined therefrom and that a particularly low body sound level in the electric motor is achieved during its intended electromotive application and motor operation. This in turn leads to a particularly low airborne sound level within a motor vehicle, in particular in the vehicle interior.

The production tolerances of the individual stator laminations, which are unavoidable in practice, can also advantageously be used in that, due to the sheet tolerances at the impact points of the stator teeth, sheet gaps occur at the yoke-side connection points into which adhesive material can penetrate during the bonding and pressing of the two stator components (stator star and stator yoke). This leads to a further improvement in the acoustic behavior of the stator and of the electric motor equipped therewith.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a stator star with radial stator teeth with adhesive applied to its free end side tooth tips,

FIG. 2 is a perspective view of the stator star which is inserted into a cylindrical stator yoke and is connected thereto without stator coils in a frictionally locked and force-locked press-fit,

FIG. 3 is a diagram of the frequency-dependent oscillation or amplitude profile of a stator without an additional integral bond between the stator yoke and the stator star without coils,

FIG. 4 is a representation according to FIG. 3 of the frequency-dependent oscillation or amplitude profile of a stator according to FIG. 2 with additional integral bond between the stator star and the stator yoke in the form of an adhesive bond with a comparatively soft silicone adhesive,

FIG. 5 is a representation according to FIG. 3 of the frequency-dependent oscillation or amplitude profile of a stator according to FIG. 2 with additional integral bond between the stator star and the stator yoke in the form of an adhesive connection with a two-component hard adhesive (GP 14),

FIG. 6 is a sectional view along the line VI-VI in FIG. 2, on a larger scale with plastic material pressed into sheet gaps between a stator tooth and the corresponding yoke-side connection point,

FIG. 7 is a perspective view of the stator star according to FIG. 1 with wound coil bodies mounted on its stator teeth, and

FIG. 8 is a partial perspective view of an electric motor with an internal rotor as well as a stator according to FIG. 6, which is wound with coils in the stator yoke in a force-locked and frictionally locked press-fit.

### DETAILED DESCRIPTION

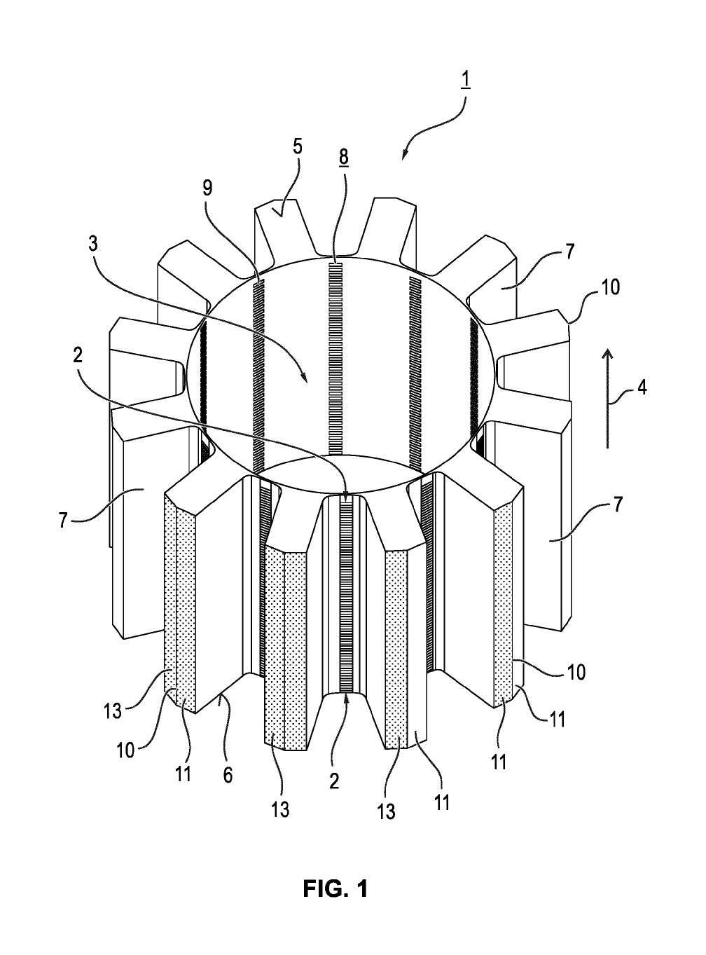

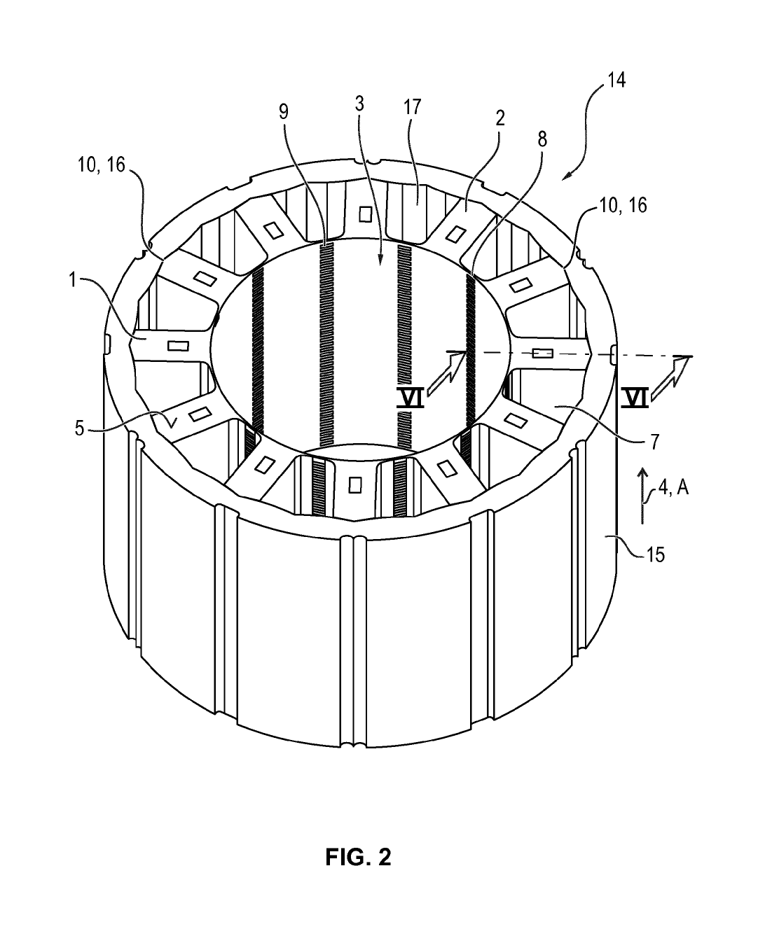

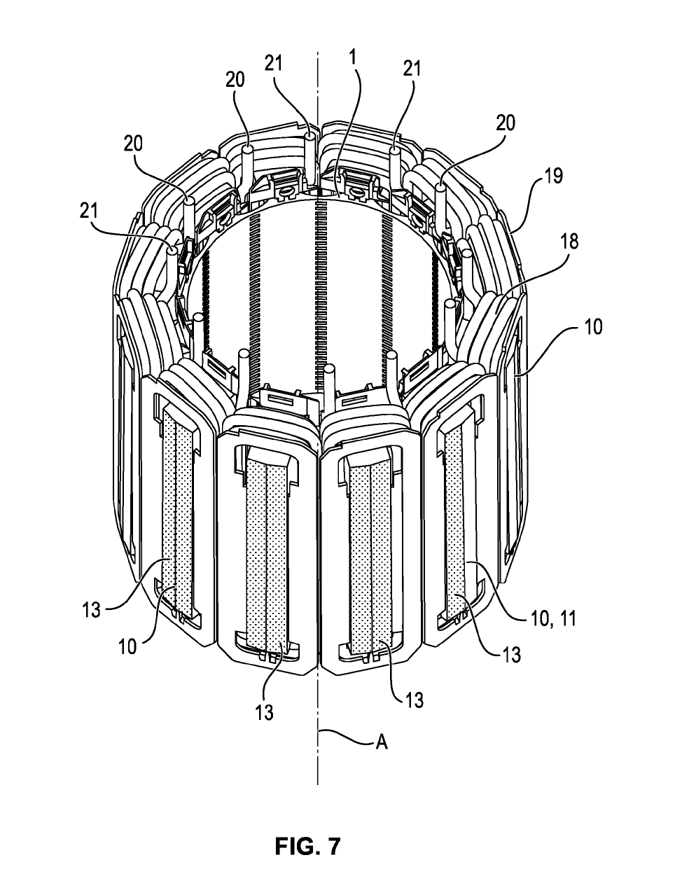

FIG. 1 shows a star-shaped stator component, which is hereinafter referred to as stator star 1, which in the exemplary embodiment is produced as a laminated core of stator laminations 2 stacked one above the other in layers. The stator laminations 2 are stacked on one another to form a central, cylindrical opening 3 in the stacking direction 4 and, for example, are stamped with one another. The stator star 1 is part of the unwound stator shown in FIG. 2, and the wound stator shown in FIG. 7, of an electric motor shown there. The laminated core of the stator core 1 terminates at the upper side 5 and lower side 6 of said stator core 1, preferably in each case with at least one stator plate 2 which is closed in the circumferential direction.

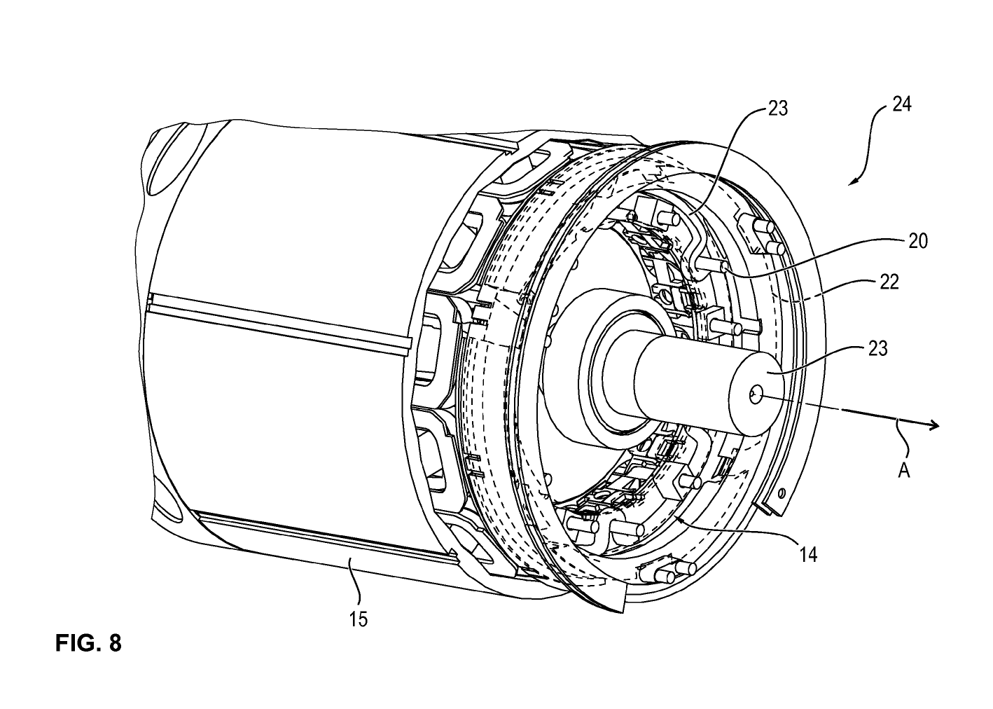

The stator star 1 comprises radially outwardly extending stator teeth 7, which form a cylindrical pole shoe 8 on the inner side located radially towards the center. The pole shoe 8, which faces the rotor of the electric motor shown in FIG. 8, is only partially closed on the circumferential side in the stacking direction 4, with the formation of gaps 9 on the pole shoe side in order to reduce a magnetic short circuit.

The stator teeth 7 are provided on the free end side with wedge-shaped tooth tips 10, forming contact surfaces 11 which are located to the left and right of a tooth tip wheel. An adhesive 13, preferably a microencapsulated two-component hard adhesive, is applied to these contact surfaces 11 and thus to the tooth tips 10 after or in the course of the manufacture of the stator star 1. In this case, both contact surfaces 11 or even only one of the contact surfaces 11 of the respective tooth tip 10 can always be coated with the adhesive 13.

FIG. 2 shows the stator 14, which is joined in a force-locked/frictionally locked press-fit from the stator star 1 and a stator yoke 15 by means of a pressing operation, wherein additionally, by means of the microencapsulated adhesive 13 applied to the tooth tips 10 of the stator teeth 7, an integral bond between the stator star 1 and the stator yoke 15 is made. The integral bonds are produced by means of the adhesive which cures after the joining process between the tooth tips 10 and the connection points 16 corresponding thereto, on the inner circumference 17 of the stator yoke 15.

The stator yoke 15 can be a cylinder jacket made of solid material or else made from stacked magnetic return ring laminations. In the assembled state, the windings, which, again, are not visible here, are laid around the stator teeth 7 of the stator star 1. Before the stator star 1 and the stator yoke 15 are joined, according to FIG. 7, the windings are mounted on winding carriers 19 as coils 18 and with said carriers 19, are placed on the stator teeth 7. Each of the frame-like winding carriers 19 carries a coil or coil winding 18 as part of the stator winding. In each case, two successive coils 18 are connected continuously and form a coil pair with the coils 18 in a series connection. The coil pairs are each contactable via two coil ends 20, 21. The overall twelve coil ends 20, 21 shown are oriented axially, i.e., in the axial direction A (direction of the motor axis), for further contacting by means of an interconnection element 22 which can be seen in FIG. 8. In electromotive operation, the energized windings produce the stator-side magnetic field, which interacts with permanent magnets of the rotor 23 of the brushless electric motor 24 rotating around the central stator or motor axis A. The small interconnection element 22 serves for contacting and interconnecting the coil ends 20, 21.

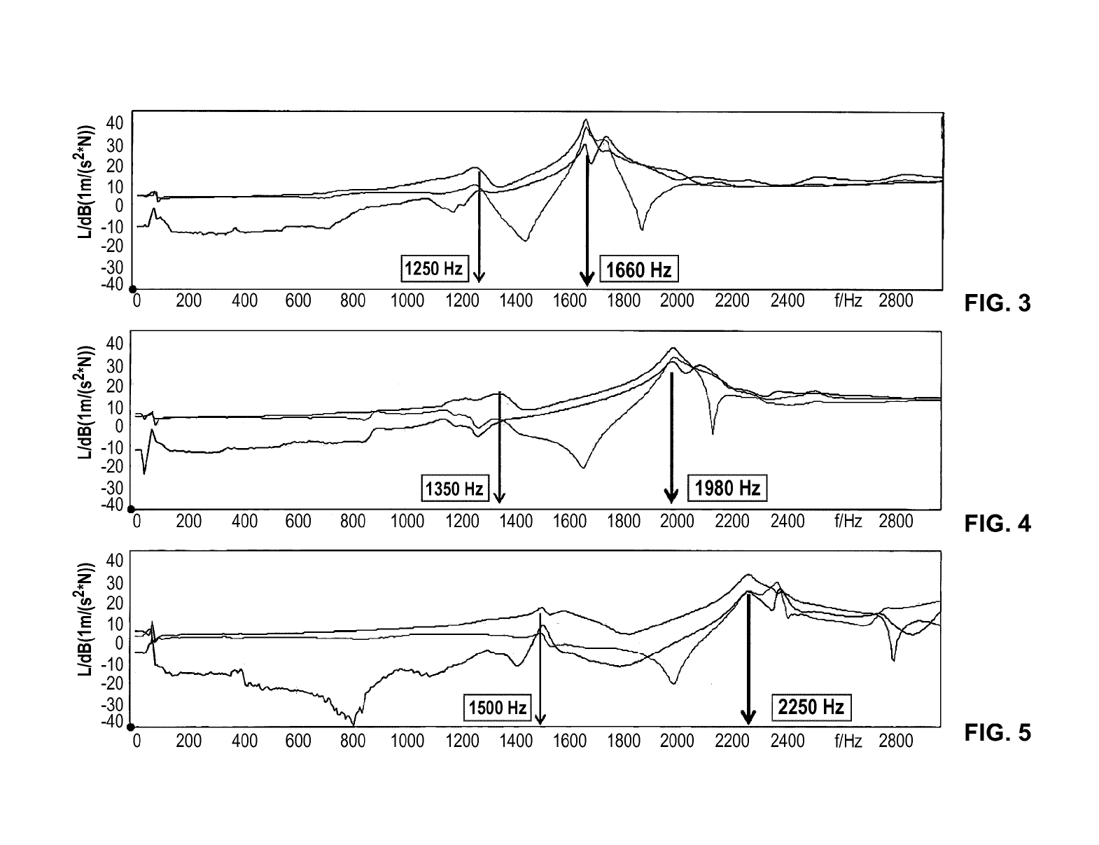

FIGS. 3 to 5 show in each case three oscillation curves over a frequency range from 0 Hz to 3000 Hz, which according to FIG. 2, were metrologically measured by a laboratory test upon introduction of oscillations on an unwound stator 14 without coils. The mechanical vibrations were introduced at the outer side of the stator yoke 15 by means of a suitable device in the form of a so-called micro-shaker. For this purpose, the stator 14 was freely suspended by means of a laboratory cord. The waveform of the introduced vibrations was white noise in the frequency range from 50 Hz to 5000 Hz. The generated vibrations were recorded on the outer side of the stator yoke 15 by means of three measurement sensors (uniaxial sensor). In this case, the measuring positions were radially aligned with stator teeth 7 in the stator star 1, the sensors being arranged offset by 60° (angular degree).

FIG. 3 shows the frequency-dependent oscillation curve, which is metrologically measured by means of the three measurement sensors. The three measurement sensors are therefore each assigned one of the three waveforms shown. The same is true for the metrologically measured waveforms shown in FIGS. 4 and 5. While the waveforms in FIG. 3 show a standard and thus conventional stator without an additional integral bond between the stator star 1 and the stator yoke 15, FIGS. 4 and 5 show the metrologically identical situation in the case of a stator 14 with an additional integral bond between the stator star 1 and the stator yoke 15. FIG. 4 shows the use of a comparatively soft single-component (1 k) silicone adhesive (type Q3 6611; Decosil) as an adhesive between the stator-side tooth tips 10 and the corresponding yoke-side connection points 16. FIG. 5 shows the measurement-technical result when using a two-component hard adhesive (2-component adhesive GP14; hard). This is a microencapsulated adhesive which advantageously unfolds its adhesive effect after prior application of the adhesive 13 to the tooth tips 10 of the stator star 1, only during the joining of the stator star 1 and the stator yoke 15 in a pressing process, and then cures at room temperature.

According to FIG. 3, significant oscillation amplitudes can be seen at approx. 1660 Hz. The reason for the deviation of the resonance frequency that is expected there at approximately 1350 Hz is due to the fact that the stator used as a test was designed without coils on its stator star 1. On the basis of the comparison of the signal profiles according to FIGS. 3 to 5, however, it can be clearly seen that the additional integral bond between the stator star 1 and the stator yoke 15 causes a displacement of this significant resonant frequency by 320 Hz to a frequency of 1980 Hz (FIG. 4) when using the silicone adhesive, and that when using the preferred microencapsulated hard adhesive, the resonance frequency is shifted by a frequency of about 600 Hz to an even higher frequency of about 2250 Hz.

A further increase in amplitude at approximately 1250 Hz of the stator produced without additional integral bond is also detectable. This increase in amplitude at about 1250 Hz, illustrated in FIG. 3, was also shifted toward higher frequencies when using an additional integral bond, namely when using a silicone adhesive, by about 100 Hz to 1350 Hz, and when using the hard adhesive, by about 250 Hz to 1500 Hz, as is again illustrated in FIGS. 4 and 5, respectively.

In the described experimental modal analysis, i.e., excitation by means of a micro-shaker as well as measurement of the generated body sound on the stator test specimen, it is thus shown that the occurring resonance frequency increases by approximately 600 Hz by means of a hard-curing, two-component adhesive. As already mentioned, no coils and no decoupling ring were mounted on the stator 14 during the laboratory measurement, which is the reason for the deviation of the resonant frequency as compared to typical, series production motor measurements. In the measurement result shown in FIG. 3, this deviation is approximately 310 Hz as compared to the typical resonance frequency of 1350 Hz mentioned above. Nevertheless, the frequency due to the additional integral bond between the stator star 1 and the stator yoke 15 is clearly shifted in the acoustically comparatively uncritical range over 1500 Hz that was mentioned above. This resonance frequency shift, which is positive overall in terms of the noise behavior of the electric motor 24, at least in its perception within the interior space of a vehicle, is attributable to the significantly increased stiffness of such a stator 14 achieved by the additional integral bond as compared to a stator or electric motor with only pressed stator stars and stator yoke.

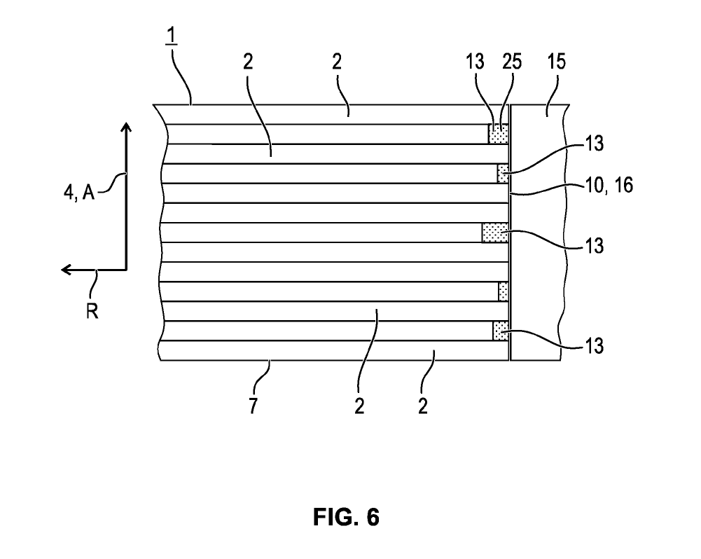

FIG. 6 shows, in a not to scale view, a typical integral bond between one of the teeth 7 of the stator star 1 and the stator yoke 15 at the corresponding yoke-side connection point 16 with the tooth tip 10 of this stator tooth 7. Due to the practically unavoidable tolerances which are typical during production and manufacture, the stator laminations 2 arranged one above the other in the stack of laminations in the stack direction 4 can be seen not completely aligned with one another in the region of the respective tooth tips 10. This leads to the formation of pockets or lamination gaps 25 whose expansion in the axial direction A of the sheet thickness of the respective stator plate 2 and expansion in the radial direction R correspond to the respective tolerance dimension.

In the course of the joining process, namely the pressing process of the stator yoke 15 with the stator star 1, adhesive material has entered in the lamination gaps or pockets 25 so that these are at least partially filled with adhesive 13. This filling of the production-related, pocket-like lamination gaps 25 between the stator teeth 7 of the stator star 1 and the connection points 16 of the stator yoke 15 during production of the additional integral bond between these stator components 1, 15 are thus used to improve the acoustic behavior of the stator 14 and of the electric motor 24 equipped with the latter in a positive and amplifying manner.

The invention is not limited to the embodiments described above. Rather, other variants of the invention can also be derived from those skilled in the art without departing from the scope of the invention. In particular, all the individual features described in connection with the exemplary embodiments can also be combined with each other in another manner without departing from the subject matter of the invention.

What is claimed is:

1. A stator for an electric motor comprising:
a cylindrical stator yoke;
a stator star which is joined with the cylindrical stator yoke; and
a plurality of radially outwardly directed stator teeth, of which tooth tips rest on corresponding connection points on an inner circumference of the stator yoke in a joined state,
wherein, in addition to a force-locked or frictionally locked press-fit connection, an integral bond is produced between the tooth tips on the stator star side and the connection points on the stator yoke side in the joined state.

2. The stator according to claim 1, wherein, between at least some of the tooth tips and the respectively corresponding connection points on the inner circumference of the stator yoke, an adhesive is applied for producing the integral bond, or a welded connection is produced as an integral bond.

3. The stator according to claim 1, wherein the tooth tips of the stator teeth are formed with wedge-shaped joining contours, and wherein the corresponding connection points on the inner circumference of the stator yoke are formed with opposing joining contours in a wedge shape.

4. The stator according to claim 1, wherein the stator star is constructed as a laminated core of stator laminations, a portion of which form pocket-like lamination gaps in a region of the tooth tips and the corresponding connection points of the stator yoke, and wherein the lamination gaps are at least partially filled with adhesive following a joining process of the stator star and the stator yoke.

5. The stator according to claim 2, wherein the adhesive is a microencapsulated adhesive or a two-component hard adhesive.

6. A method for manufacturing a stator according to claim 1, the method comprising:
providing a cylindrical stator yoke and a stator star with a plurality of radially outwardly directed stator teeth, and on each of which a coil of a stator winding is mounted;
during a pressing process, the stator star which is provided with the coils and the stator yoke are joined together with a formation of connection points between the tooth tips of the stator teeth and the stator yoke;
providing, before the joining process, at least some of the connection points between the cylindrical stator yoke and the stator star with an adhesive; and
pressing the stator yoke onto the stator star or pressing the stator star into the stator yoke.

7. The method according to claim 6, wherein, before the joining process, a microencapsulated hard adhesive is applied as an adhesive to the tooth tips or to wedge-shaped contact surfaces of the stator teeth.

8. A method for producing a stator according to claim 1, the method comprising:
providing a cylindrical stator yoke and a stator star with a plurality of radially outwardly directed stator teeth, and on each of which a coil of a stator winding is mounted;
joining together, a pressing process, the stator star which is provided with the coils and the stator yoke such that a formation of connection points between the tooth tips of the stator teeth and the stator yoke occurs; and
following the joining process, the stator star and stator yoke are welded to one another in a region of the star-side tooth tips and the corresponding connection points on the yoke side.

9. An electric motor comprising a stator according to claim 1.

10. The stator according to claim 1, wherein the electric motor is a steering motor of a motor vehicle
